(19) United States
(12) Patent Application Publication
(10) Pub. No.: US 2004/0076558 A1
(43) Pub. Date: Apr. 22, 2004

(54) Fire smoke cleaner

(76) Inventor: Hans Beckman, Molndal (SE)

Correspondence Address: Samuels, Gauthier & Stevens LLP, Suite 3300, 225 Franklin Street, Boston, MA, 02110, US

(21) Appl. No.: 10/649,225

(22) Filed: Aug. 26, 2003

Related U.S. Application Data
(63) Continuation of application No. PCT/SE02/00340, filed on Feb. 26, 2002.

(30) Foreign Application Priority Data
Feb. 26, 2001 (SE) 0100636-0

(51) Int. Cl. B01D 53/34

(52) U.S. Cl. 422/177; 422/171

(57) ABSTRACT

The present invention relates to a Fire smoke cleansing device for personal use and comprising a particle filter, carbon monoxide filter and a filter for acidic gases, whereby it comprises a rectangular oblong house, which in one end comprises a number of inlet openings arranged over an end surface for a gaseous medium, in connection to the inlet openings a filter space is arranged containing in the order given from the inlet openings: a) a particle filter; b) a catalyst for the oxidation of carbon monoxide to carbon dioxide to eliminate carbon monoxide present in said gaseous medium; and c) a filter mass for elimination of acidic gases, in connection to the filter space a valve chamber is arranged comprising two one-way valves to provide a controlled flow of gas through said filter space and a bite mouth piece arranged to the valve chamber at the opposite end of the house for providing ventilation, as well as package containing such a fire smoke cleansing device.

### DESCRIPTION

1. Technical Field

The present invention relates to a fire smoke cleansing device for personal use and comprising a particle filter, a carbon monoxide filter and a filter for acidic gases.

The object of the present invention is to obtain a fire smoke cleansing device for personal use which device can be carried in a pocket but still contains a protective equipment and material as a complete gas mask.

2. Background of the Invention

A number of difficult fires during the last years have brought the focus on the necessity of having readily available fire smoke cleansing devices for personal use.

Thus many people die in fires by inhaled carbon monoxide which blocks the oxygen transporting properties of the haemoglobin, by particles which enter the lungs and prevent air exchange, as well as by acidic gases which damage the lung tissue.

Acidic gases comprises propenal (acroleine), hydrochloric acid in gas phase as well as hydrogen cyanide and furthermore carbon monoxide.

Gas masks are known since long, which masks, however, require a large space in the form of a shoulder bag. Further the gas mask is complicated to use as a number of bands have to be brought over the head and around the neck. Further the gas mask requires maintenance as the material which forms the face protection ages and thus has to be maintained by exchange, washing, lubrication depending on the type of material used. Besides the fact that the mask requires space while stored it also requires a large space on the face and in front of the face, and is thus demanding to use. In itself it provides a resistance to use.

It has thus been requested a fire smoke cleansing device which meets the requirements of cleaning the fire smoke from a technical point of view to innocuous levels, simultaneously as it shall be adaptable to use and to carry.

### DESCRIPTION OF THE PRESENT INVENTION

It has now surprisingly been shown possible to be able to solve this problem by means of the present invention which is characterized in that it comprises a rectangular oblong house, which in one end comprises a number of inlet openings arranged over an end surface for a gaseous medium, in connection to the inlet openings a filter space is arranged containing in the order given from the inlet openings a) a particle filter, b) a catalyst for the oxidation of carbon monoxide to carbon dioxide to eliminate carbon monoxide present in said gaseous medium, and c) a filter mass for elimination of acidic gases, in connection to the filter space a valve chamber is arranged comprising two one-way valves to provide a controlled flow of gas through said filter space and a bite mouth piece arranged to the valve chamber at the opposite end of the house for providing ventilation.

Further characteristics are evident from the accompanying claims.

In a preferred embodiment of the invention the valve space comprises an opening provided with a first one-way valve arranged to the filter space, whereby this first one-way valve controls the transport of gas from the inlet openings to the bite mouth piece, and an outlet opening having a second one-way valve for outgoing respiration air, whereby said second one-way valve prevents respiration through the outlet opening.

In another preferred embodiment of the invention a distribution space is arranged between the inlet openings of the house.

In another further preferred embodiment of the invention the catalyst is a cupper oxide/manganese oxide.

In a further preferred embodiment of the invention a sound producing means is connected to the valve chamber and is arranged to provide a sound at exhaustion through the valve chamber.

In another preferred embodiment of the invention the house is provided with a fluorescent dye.

By means of the present invention a fire smoke cleansing device is obtained which has an active time of at least 15 minutes and allows evacuation of a room at fire or escape from fire smoke. By its limited size, insignificantly larger and heavier that a package of cigarettes it will be simple to carry, will be easily distributed and will not prevent use.

The invention will now be described with reference to a preferred embodiment thereof and with reference to the accompanying drawing, wherein

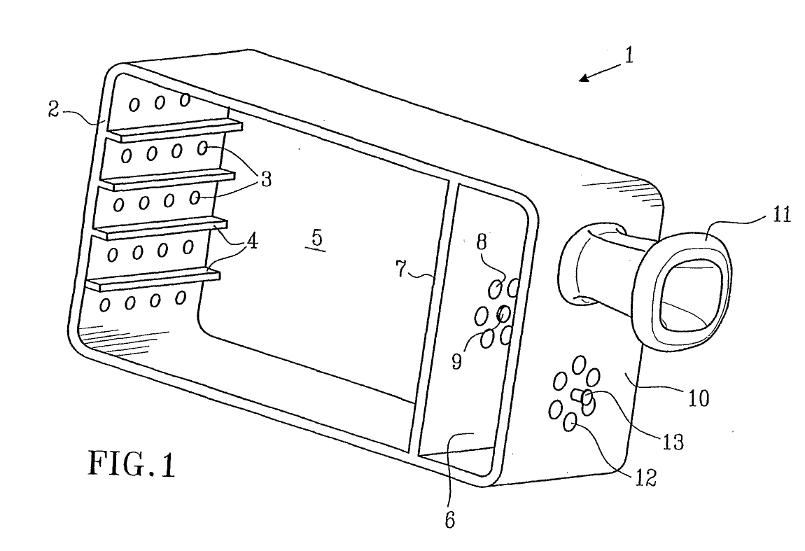

FIG. 1 shows a perspective view of a house without side walls, in accordance with the present invention;

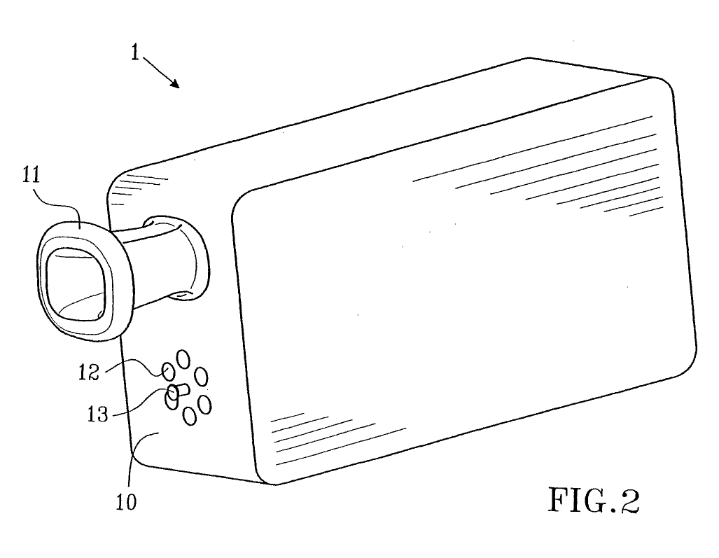

FIG. 2 shows another perspective view of the house according to FIG. 1 having side walls;

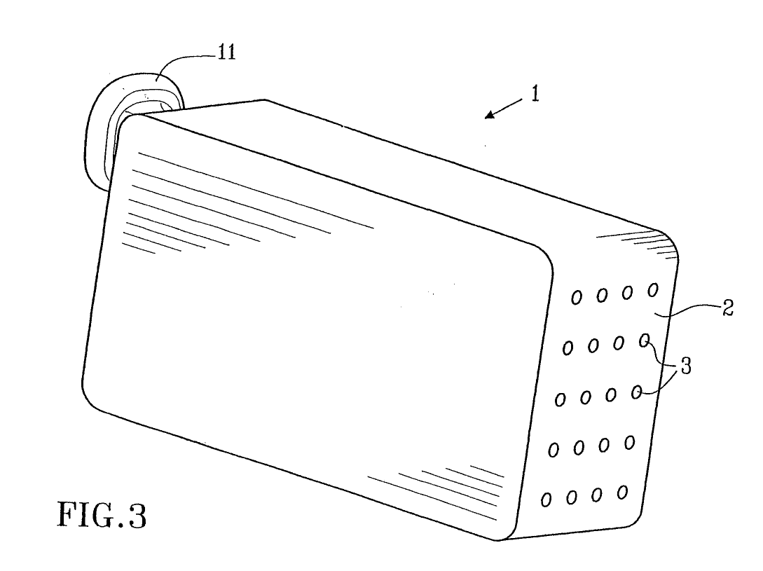

FIG. 3 shows an end view of the house according to FIGS. 1-2;

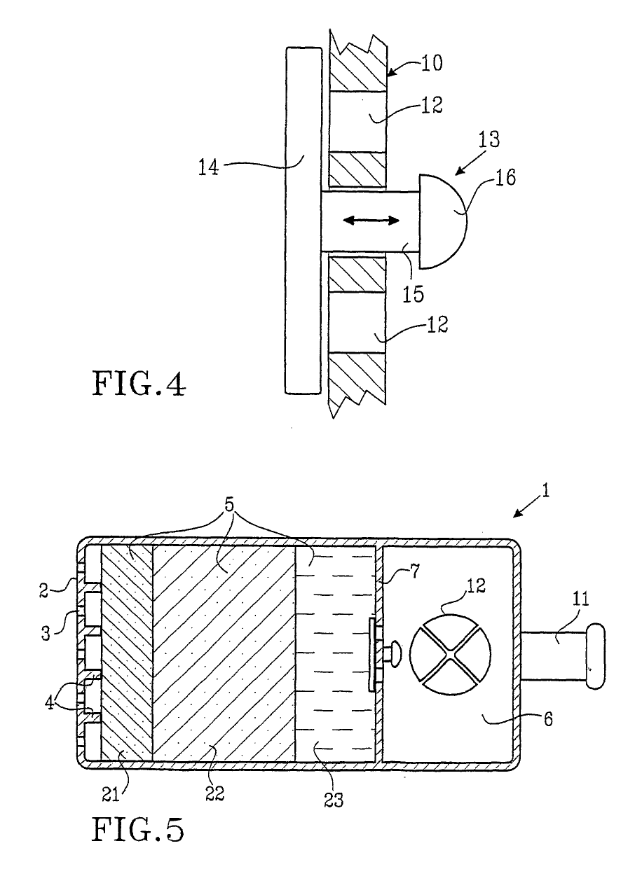

FIG. 4 shows an enlarged side view of a one-way valve in a house according to the present invention;

FIG. 5 shows a view from above of the filter and valve chamber in a device according to the present invention.

1 denotes a combined filter and valve house made of polypropylene or another polymer suitable for moulding or a similar production process. The house has a general rectangular shape having a length to short end ratio of about 2:1 and a length to high side ratio of about 3:1. The house has a total size of about the size of a package of cigarettes, but this size may of course be varied due to technical factors and environmental requirements, e.g., slimmer but longer. In one end surface 2 of the house there are a number of inlet openings 3 through going arranged, which openings are distributed equally over the end surface 2. On the end surface 2 on the inside of the house 1 a number of distance means 4 are arranged in order to create a distribution space of a first filter part of the filter space 5 of the house. In the filter space a particle filter 21 is arranged which occupies about ⅕^{th} of the space 5. This particle filter 21 is arranged closest to the inlet openings 3 and the filter of gas mask quality according to military standards, i.e., it does not any particles of considerable size, i.e., not larger than 0.10 μm through, preferably not larger than 0.05 μm, more preferably not larger than 0.03 μm. The filter nomination is hereby P3. Such a filter 21 is classified according to EN 143 of the Commitee for Standardization, EU, Bryssel, BE. In the following half of the space 5 a catalyst 22 for the oxidation of carbon monoxide arranged. This catalyst consists of a mixed valence oxide, such as cupper oxide/manganese oxide, such as Moleculite^{R} or Hopcalite^{R}. Besides oxidation of carbon monoxide the ozone concentration, ethylene oxide emissions, dampening of volatile organic components as well as removal of hydrogen is controlled. Such a filter 22 which is present in granular form and packed in granular form into the filter space 5 is classified according to EN 403 of the

Commitee for Standardization, EU, Bryssel, BE. In the remaining part of the space 5 there is a filter 23 which is present in the form of a block, for acidic gases, which filter 23 neutralizes these by reducing them to respirable air. Such a filter 23 is classified according to EN 141 by the Commitee for Standardization, EU, Bryssel, BE.

Separately from the filter space 5 is a valve space 6, divided from the filter space by a wall 7 provided with a through going hole 8. In connection with these openings 8 a one-way valve 9 is arranged. In an opposite wall 10, opposite the end wall 2, there is on one hand a bite mouth piece 11, and on the other hand an outlet opening 12 arranged. A one-way valve 13 is also arranged at the outlet opening 12. The one-way valve 9 is arranged to control the air flow from the filter space to the valve space 6, while the one-way valve 13 is arranged to control an air flow from the valve space and out off the device 1. The bite mouth piece 11 is arranged as the nomination calls for to be bitten around and be an in-and-out respiration channel.

The one-way valves 9, 13 comprises a valve seat 14, a shaft 15 and a locking tab 16, whereby the shaft 15 has the task to keep the one-way valve at its site in the opening areas 8, 12 and allow the valves 9, 13 to move to and fro, while the valve seat has the task of locking the opening areas 8, 12. The locking tab 16 has the task of maintaining the one-way valves 9, 12 in their holes.

The fire smoke cleansing device 1 is provided with side walls so that fire smoke can not pass into the valve space in any other way than through the end wall 2 and thereby it has to pass the filters. FIG. 1 shows one side wall being eliminated.

In tests carried out the carbon monoxide reducing effect of the fire smoke cleansing device have been studied. Hereby test gas, carbon monoxide containing nitrogen gas, was intermittently drawn through a fire smoke cleansing device according to the invention in an amount of 100 ppm CO and a flow of 10 I/min through the device. The total flow was thereby 5 I/min. After 2 minutes a constant flow of 10 l/min was drawn through the device, and then after 7 minutes, 15 I/min and after 9 minutes to 15 minutes 20 I/min were constantly drawn through the device. Table 1 provides the results obtained.

TABLE 1

| Test time | Gas flow | Monitored outgoing |
|---|---|---|
| (min) | (l/min) | amount of CO (ppm) |
| 0-2 | 10 (interm. 3 s) | 14 |
| 2-7 | 10 (constant) | 17 |
| 7-9 | 15 (constant) | 22 |
| 9-15 | 20 (constant) | 36 |

As evident from the Table a qualified reduction of the amount of CO is obtained after a passage of the filters.

With regard to the properties of the filters these should be stored in a dry place and the whole fire smoke cleansing device 1 is therefore suitably packed in a tightly closing outer envelope (not shown) in which outer envelope further protection equipment to fire smoke influence is contained, such as a nose clamp and a pair of glasses, type swimming glasses, as well as a drying agent.

The outlet opening of the valve space may suitably contain a sound providing means, such as a drilling pipe in order to facilitate localisation in a room filled by fire smoke. In the same way the package and the device may be provided with a fluorescent dye to more easily make it visible in a weak light.

It is apparent to the one skilled in the art that the invention can be varied within the frame work of the accompanying claims and is not restricted to the embodiment shown herein.

1. Fire smoke cleansing device for personal use and comprising a particle filter,
carbon monoxide filter and a filter for acidic gases,
characterized in
that it comprises a rectangular oblong house (1), which in one end comprises a number of inlet openings (3) arranged over an end surface (2) for a gaseous medium, in connection to the inlet openings (3) a filter space (5) is arranged containing in the order given from the inlet openings a) a particle filter (21), b) a catalyst (22) for the oxidation of carbon monoxide to carbon dioxide to eliminate carbon monoxide present in said gaseous medium, and c) a filter mass (23) for elimination of acidic gases, in connection to the filter space (5) a valve chamber (6) is arranged comprising two one-way valves (9, 13) to provide a controlled flow of gas through said filter space and a bite mouth piece (11) arranged to the valve chamber (6) at the opposite end (10) of the house for providing ventilation.

2. Fire smoke cleansing device according to claim 1,
wherein the valve space (5) comprises an opening (8) provided with a first one-way valve (9) arranged to the filter space, whereby this first one-way valve controls the transport of gas from the inlet openings to the bite mouth piece (11), and an outlet opening (12) having a second one-way valve (13) for outgoing respiration air, whereby said second one-way valve prevents respiration through the outlet opening.

3. Fire smoke cleansing device according to claim 1 or 2,
wherein a distribution space is arranged between the inlet opening of the house.

4. Fire smoke cleansing device according to claim 1,
wherein the catalyst for the oxidation of carbon monoxide is a mixed valence oxide.

5. Fire smoke cleansing device according to claim 4,
wherein the catalyst is a cupper oxide/manganese oxide.

6. Fire smoke cleansing device according to claims 1-5,
wherein a sound producing means is connected to the valve chamber and is arranged to provide a sound at exhaustion through the valve chamber.

7. Fire smoke cleansing device according to one or more of claims 1-6,
wherein the house is provided with a fluorescent dye.

8. Tightly closing package containing a fire smoke cleansing device according to one or more of claims 1-7, as well as moreover further protection equipment to fire smoke influence.

9. Package according to claim 8, wherein it further contains a drying agent.
